(19) United States
(12) Patent Application Publication
(10) Pub. No.: US 2016/0320923 A1
(43) Pub. Date: Nov. 3, 2016

(54) DISPLAY APPARATUS AND USER INTERFACE PROVIDING METHOD THEREOF

(71) Applicant: Samsung Electronics Co., Ltd., Suwon-si (KR)

(72) Inventors: Imtiaz Md. HOSSAIN, Dhaka (BD); Nizam Uddin AHMED, Chittagong (BD); Nafiul S. M. HOSSAIN, Dhaka (BD)

(21) Appl. No.: 14/873,497

(22) Filed: Oct. 2, 2015

(30) Foreign Application Priority Data
Apr. 29, 2015 (KR) 10-2015-0060553

(51) Int. Cl. G06F 3/0482; G06F 3/0484; G06F 3/0485; G06F 3/0488

(52) U.S. Cl. CPC G06F 3/0482; G06F 3/04886; G06F 3/04842; G06F 3/0485

(57) ABSTRACT

A display apparatus is provided. The display apparatus includes a display, and a processor configured to control the display to provide a first graphical region having user interface elements along a radial direction in fixed positions and a second graphical region having second user interface elements along the radial direction in scrollable positions.

### CROSS-REFERENCE TO RELATED APPLICATION(S)

This application claims the benefit under 35 U.S.C. §119(a) of a Korean patent application filed on Apr. 29, 2015 in the Korean Intellectual Property Office and assigned Serial number 10-2015-0060553, the entire disclosure of which is hereby incorporated by reference.

### TECHNICAL FIELD

The present disclosure relates to a display apparatus and a user interface providing method thereof. More particularly, the present disclosure relates to a display apparatus which provides a user interface for an interaction with a user, and a user interface providing method thereof.

### BACKGROUND

In recent years, various display apparatuses are provided to users due to the development of electronic technology. In particular, smart phones, tablet personal computers (PCs), and the like have been already widespread, and wearable apparatuses having a wearable form such as smart glasses or wrist watches have been developed.

The wearable apparatuses have been manufactured in a small size in consideration of convenience, portability, and the like for the users.

Therefore, there is a need for a method for providing a user interface (UI) for effectively performing an interaction with the user through a small screen.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a display apparatus which fixedly displays user interface (UI) elements in one part of a UI and scrollably displays UI elements in the other part of the user interface.

In accordance with an aspect of the present disclosure, a display apparatus is provided. The display apparatus includes a display and a processor configured to control the display to provide a first user interface having first user interface elements arranged in a radial direction in fixed positions and a second user interface having second user interface elements in the radial direction in scrollable positions.

The first graphical region and the second graphical region may be coupled to each other to form an annulus.

The user interface elements in the first graphical region may have a higher priority than the user interface elements in the second graphical region.

In response to a user input for selecting one a first user interface element from the second graphical region, the processor may be further configured to display a sub user interface element for the first user interface element in the second graphical region.

The processor may display the first user interface element in a third graphical region disposed between the first graphical region and the second graphical region.

In response to a user input for selecting the first user interface element displayed in the third graphical region, the processor may be further configured to display the selected user interface element in the second user interface.

In response to a user input for selecting a second user interface element from the first graphical region, the processor may display a sub user interface for the second user interface element in the second graphical region.

In accordance with another aspect of the present disclosure, a method of providing a user interface of a display apparatus is provided. The method includes providing a first graphical region having user interface elements along a radial direction in fixed positions, and providing a second graphical region having user interface elements along the radial direction in scrollable positions.

The first graphical region and the second graphical region may be coupled to each other to form an annulus.

The user interface elements in the first graphical region have a relatively higher priority than the user interface elements in the second graphical region.

The method may further include, in response to a user input for selecting a first user interface element in the second graphical region, displaying a sub user interface element for the first user interface element in the second graphical region.

The method may further include, in response to a user input for selecting the first user interface element displayed in the third graphical region, displaying the selected user interface element in the second user interface.

The method may further include, in response to a user input for a second user interface element from the first graphical region, displaying a sub user interface for the second user interface element in the second graphical region.

According to various embodiments of the present disclosure, the interaction with the user may be enabled by providing user interfaces even in a display apparatus having a small-sized screen in that user interface elements are fixedly arranged in one part of a user interface and user interface elements are scrollably arranged in the other part of the user interface.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a display apparatus according to an embodiment of the present disclosure;

FIGS. 2, 3A, 3B, 3C, 3D, 4A, 4B, 5A, 5B, 5C, 5D, 6, 7A, 7B, 7C, 7D, 7E, 7F, 7G, 7H, 8A, 8B, 8C, 8D, 9, 10, 11, and 12 are diagrams illustrating user interfaces (UIs) according to various embodiments of the present disclosure;

FIG. 13 is a block diagram of a display apparatus according to an embodiment of the present disclosure; and

FIG. 14 is a flowchart of a user UI providing method of a display apparatus according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

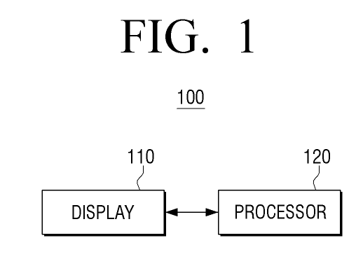

FIG. 1 is a block diagram of a display apparatus according to an embodiment of the present disclosure.

Referring to FIG. 1, a display apparatus 100 may be implemented with, for example, a smart phone, a laptop personal computer (PC), a personal digital assistant (PDA), a media player, a moving picture experts group phase 1 or phase 2 (MPEG-1 or MPEG-2) audio layer 3 (MP3) player, a micro server, a global positioning system (GPS) device, an electronic book (i.e., e-book) terminal, a digital broadcast terminal, a kiosk, an electronic frame, a navigator, or the like. In another example, the display apparatus may be implemented with a wearable device such as smart glasses, a wrist watch, or a head-mounted display (HMD).

As illustrated in FIG. 1, the display apparatus 100 may include a display 110 and a processor 120.

The display 110 may be configured to display various screens. The display 110 may display a user interface (UI) (or a UI screen) in which feedback is possible according to a user input through an interaction with the user.

The UI may include a UI element represented by an element such as an icon, an image, text, and a moving image. The UI may be represented by a menu and the like and may receive a user command.

For example, the UI may be provided through a home screen or an application execution screen. The UI may be a menu item for executing an application or a menu item and the like for executing a function provided from an application. The UI may include various pieces of information provided from the application.

The implementation type of the display 110 is not limited thereto. For example, the display 100 may be implemented with various types of displays such as a liquid crystal display (LCD), an organic light emitting diode (OLED), an active-matrix OLED (AMOLED), or a plasma display panel (PDP).

In this example, the display 110 may further include additional configuration components according to the implementation type. In response to the display 110 being implemented with an LCD type, the display 110 may include an LCD display panel (not shown), a backlight unit (not shown) configured to supply light to the LCD panel, a panel driver board (not shown) configured to drive the LCD display panel, and the like.

The display 110 may be coupled to various sensors and receive a user input for a UI.

For example, the display 110 may detect a touch input from the user's body such as a finger, a stylus, and the like, through a touch sensor disposed on a rear of a display panel. In another example, the display 110 may detect a touch input from a pen (for example, a digitizer pen) or a proximity touch input through a pen recognition panel disposed on a rear of the display panel.

The processor 120 may control overall operation of the display apparatus 100. The processor 120 may include a microcomputer (or a microcomputer, a microcontroller, and a central processing unit (CPU)), and a random access memory (RAM) and a read only memory (ROM) for an operation of the display apparatus 100.

The processor 120 may control the display 110 to provide a UI.

Specifically, in response to an event, the processor 120 may control the display 110 to display the UI on a screen.

For example, in response to a home screen being displayed by either turning on, unlocking of the display apparatus 100, or a specific event being generated on the home screen (for example, a button provided in the display apparatus 100 being pressed or a touch input), the processor 120 may display the UI on the home screen. In another example, in response to an application execution screen being displayed by execution of the application or a specific event being generated on the application execution screen, the processor 120 may display the UI on the application execution screen.

The processor 120 may control the display 110 to receive a user input for the UI.

Specifically, the processor 120 may control the display 110 to detect the user input in the UI, and may determine the user input based on the detected user input that is acquired from the display 110.

For example, in response to detecting a touch input or a proximity touch input for the UI, the display 110 may provide the information for the touch input or proximity touch input to the processor 120. The processor 120 may determine the kind of touch or proximity touch (for example, tap, scroll, and the like) by acquiring information such as coordinates or a length of time of the touch or proximity touch from the display 110.

Hereinafter, UIs according to various embodiments of the present disclosure will be described in detail with reference to the accompanying drawings.

The processor 120 may control the display 110 to provide a first UI in which a plurality of UI elements are fixedly arranged to a clockwise direction or a counterclockwise direction, and a second UI in which a plurality of UI elements are scrollably arranged to the clockwise direction or the counterclockwise direction.

Positions of the plurality of UI elements in the first UI may not change according to the user input in that the plurality of UI elements that are fixedly arranged in the first UI. That is, the first UI may be fixed.

That is, even in response to the user input such as scroll being input to the first UI, the processor 120 may not change the positions of the plurality of UI elements included in the first UI.

Positions of the plurality of UI elements in the second UI may be changed according to the user input. That is, the second UI may be scrollable.

For example, in response to the scroll being input to the second UI in which the plurality of UI elements are arranged in a radial direction, the processor 120 may move the plurality of UI elements displayed in the second UI according to the radial direction.

In this example, the second UI may be configured to include a visible part and an invisible part.

Specifically, the visible part includes UI elements that are displayed on the screen and the invisible part includes UI elements that are not displayed on the screen.

Accordingly, in response to the scroll being input into the visible part, the processor 120 may move UI elements included in the visible part into the invisible part and move the UI elements included in the invisible part to the visible part, based on a direction and length of the input scroll.

For example, it may be assumed that a scroll having a length which enables the UI element to move one item is input to the counterclockwise direction (or the right direction).

In this example, the processor 120 may move the UI element included in the second UI by one item to the radial direction.

Accordingly, a UI element included in the visible part may be moved to the invisible part and may not be displayed on the screen. A UI element included in the invisible part may be moved to the visible part and displayed on the screen.

That is, the second UI may include UI elements arranged in a radial direction in a virtual circular region. Therefore, it may be seen that the UI elements may be moved from the visible part to the invisible part or from the invisible part to the visible part in response to the scroll input.

The plurality of UI elements included in the first UI may have a higher priority than the plurality of UI elements included in the second UI.

For example, a menu item for executing an application may be displayed in the first UI, and a menu item for executing a function of the application may be displayed in the second UI.

In another example, a menu item for executing a function of an application may be displayed in the first UI, and content provided from the application may be displayed in the second UI.

In another example, a menu item having high frequency of use may be displayed in the first UI, and a menu item having low frequency of use may be displayed in the second UI.

For example, the UI elements displayed in the first UI and the second UI may be determined according to applications providing UIs based on the priority. In another example, the UI elements displayed in the first UI and the second UI may be determined by the user.

The processor 120 may display the UI elements in the first UI and the second UI in different styles.

For example, the processor 120 may display UI elements having different sizes in the first UI and the second UI or may display different quantity of UI elements in the first UI and the second UI.

The first UI and the second UI may be coupled to each other in a circular shape such as, for example, an annulus.

That is, the processor 120 may display the first UI and the second UI on the screen so that UI elements located at both sides in the first UI to the clockwise direction or the counterclockwise direction are close to UI elements located at both sides in the visible part of the second UI to the clockwise direction or the counterclockwise direction.

Therefore, the UI elements included in the first UI and the UI elements included in the second UI (specifically, visible part) may be arranged in a circular shape or a radial shape such as, an annulus.

The processor 120 may control the display 110 to provide a separate UI in a region between the first UI and the second UI. For example, the processor 120 may display a separate UI in the inner (i.e., open) region of an annulus.

For example, the processor 120 may control the display 110 to provide a circular UI (for example, referred to as content view) in the region between the first UI and the second UI. That is, because the first UI and the second UI may be formed by different concentric circles with different radii (e.g., R₂>R₁), the content view is disposed between the first and second UIs and has a circular region having a radius of the smallest circle, for example.

In this example, the processor 120 may display a UI element selected by the user among a plurality of UI elements included in the first UI and the second UI, a UI element related to an application providing the first UI and the second UI, and a UI element (for example, a home key) for receiving a user input for displaying a home screen in the circular UI.

The processor 120 may control the display 110 to provide a UI between at least one of the first UI and the second UI and the circular UI.

For example, in response to the size of the first UI being different from that of the second UI, an empty region may be provided between the at least one of the first UI and the second UI and the circular UI.

In this example, the processor 120 may further display a UI between the at least one of the first UI and the second UI and the circular UI.

In this example, the processor 120 may display a UI element indicating information (for example, summary information or depth information) for a UI element selected from the plurality of UI elements included in the first UI and the second UI in the UI.

The UI may serve as a navigation panel indicating a depth of the UI element, and the depth information indicates a depth level of the UI element recently selected by the user.

In response to a scroll for a UI being received when the plurality of UI elements are included in the UI displayed between the at least one of the first UI and the second UI and the circular UI, the processor 120 may perform the scroll on the plurality of UI elements included in any of the UIs.

Hereinafter, UIs according to various embodiments of the present disclosure will be described in detail with reference to the accompanying drawings.

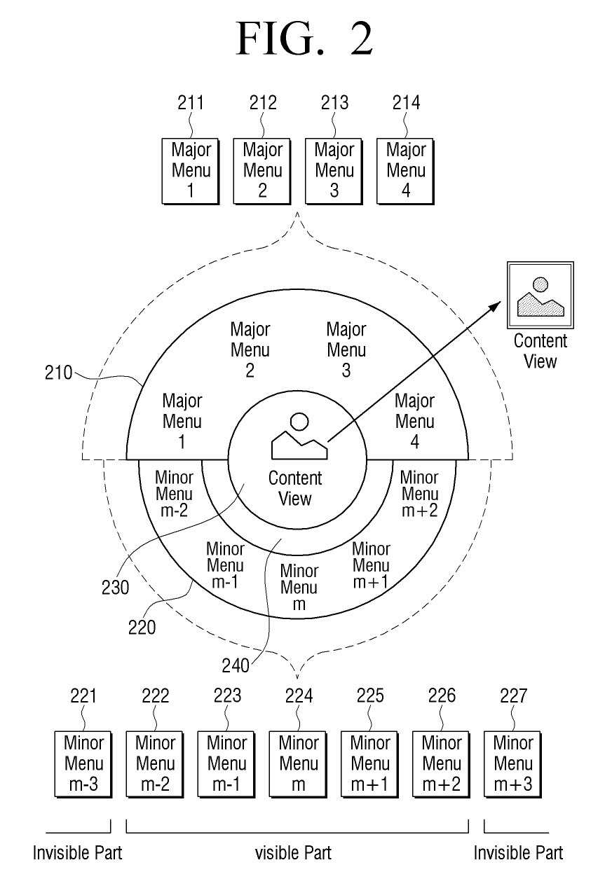

FIGS. 2, 3A, 3B, 3C, 3D, 4A, 4B, 5A, 5B, 5C, 5D, 6, 7A, 7B, 7C, 7D, 7E, 7F, 7G, 7H, 8A, 8B, 8C, 8D, 9, 10, 11, and 12 are diagrams illustrating UIs according to various embodiments of the present disclosure.

For clarity, FIGS. 2 to 4B illustrate that UI elements included in a first UI and a second UI are menu items.

Referring to FIGS. 2 to 4B, a menu item included in the first UI is illustrated as “Major menu” and a menu item included in the second UI is illustrated as “Minor menu”.

The processor 120 may control the display 110 to provide a first UI 210 and a second UI 220. The first UI 210 and the second UI 220 may be displayed in a circular shape such as an annulus. As illustrated in FIG. 2, the first UI is a semi-annulus formed by two concentric circles with radius R₁ and R₂ (not shown). The second UI 220 is semi-annulus formed by two concentric circles with R₃ and R₄ (not shown). Each radii is different such that R₁>R₃>R₄>R₂ as illustrated in FIG. 2. In other examples, the inner and outer radii of each semi-annulus may be equal (i.e., R₁=R₃ and R₂=R₄).

For example, as illustrated in FIG. 2, the first UI 210 may include four menu items 211 to 214 arranged in a clockwise direction or a counterclockwise direction, and the second UI 220 may include seven menu items 221 to 227 arranged in the clockwise direction or the counterclockwise direction.

In this example, the menu items 211 to 214 may be fixed such that the positions of the menu items may not be changed according to a user input.

The menu items 221 to 227 may be scrollably arranged, and positions of the menu items 221 to 227 may be changed according to a user input.

That is, five menu items 222 to 226 may be included in a visible part and displayed on a screen, and the remaining two menu items 221 and 227 may be included in the invisible part (i.e., a non-rendering region) and may not be displayed on the screen. For example, as illustrated in FIG. 2, the menu items 221 and 227 may be covered by the first UI 210 and therefore not rendered.

In response to a scroll for the second UI 220 being received, the processor 120 may perform a scroll operation on the seven menu items 221-227 included in the second UI 220.

For example, in response to a scroll input to move the second UI 220 by one position, the processor 120 may move the seven menu items 221-227 included in the visible part and the invisible part by one position in the clockwise direction. The scroll input may be configured to move the menu items 221-227 in any radial direction.

In this example, the menu items 223-226 may move to regions in which the menu items 222-225 are located.

The menu item 222 located in the furthermost end to the clockwise direction among the plurality of menu items 222-226 may be moved to the invisible part. That is, the menu item 221 may be moved to a region in which the menu item 227 is located, and the menu item 222 may be moved to a region in which the menu item 221 is located.

The menu item 227, which is located in the furthermost end to the clockwise direction in the invisible part may be moved to the visible part. That is, the menu item 227 may be moved to the visible region in which the menu item 226 is located.

Accordingly, through the scroll input, the menu items may be selectively moved into the visible region and invisible region.

Referring to FIG. 2, the UIs 210 and 220 may be referred to as “quasi-scrollable radial menus” in that the menu items in the first UI 210 and menu items in the second UI 220 may be arranged in a circular shape. The menu items in the first UI are in a fixed position and the menu items in the second UI are movable and selectively displayed.

The processor 120 may control the display 110 to provide UIs 230 and 240 in a region between the first UI 210 and the second UI 220.

For example, the processor 120 may display a menu item selected by the user among the menu items included in the first UI 210 and the second UI 220 in the circular UI 230, which has a radius of the smallest circle implemented by the first UI 210 and second UI 220.

In another example, the processor 120 may display the UI 240 in a region between the second UI 220 and the circular UI 230. That is, the UI 240 is also a semi-annulus that is formed within the boundaries of the first UI 210 and the second UI 220 due to different radii associated with the first UI 210 and the second UI 220.

In this example, the processor 120 may display information for the menu item selected by the user among the menu items included in the first UI 210 and the second UI 220 in the UI 240.

It has been described in FIG. 2 that the UI 240 is displayed between the second UI 220 and the UI 230.

That is, because there are fewer menu items in the first UI 210 than the second UI 220, the UI 240 may be displayed between the first UI 210 and the UI 230.

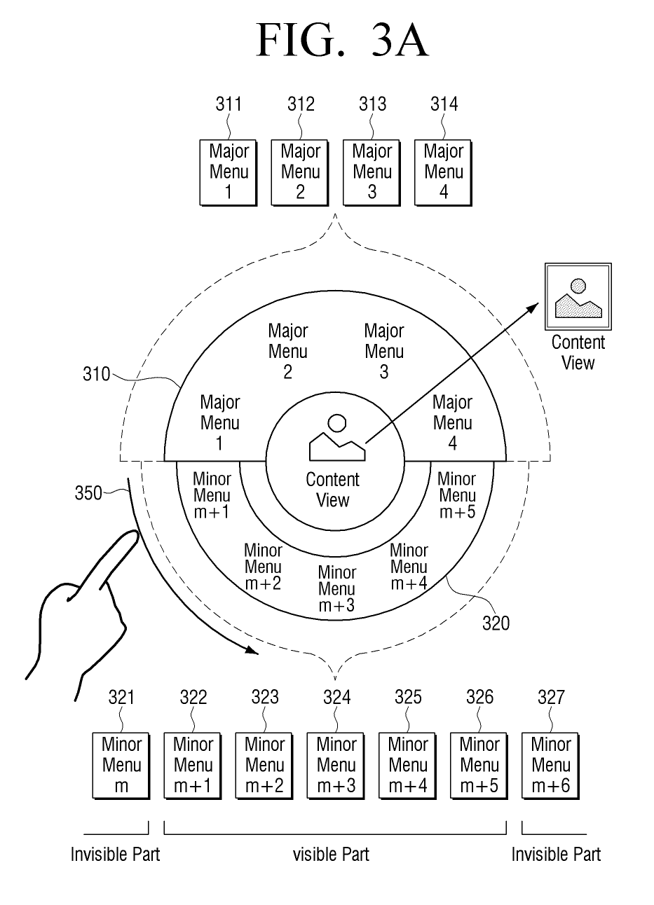

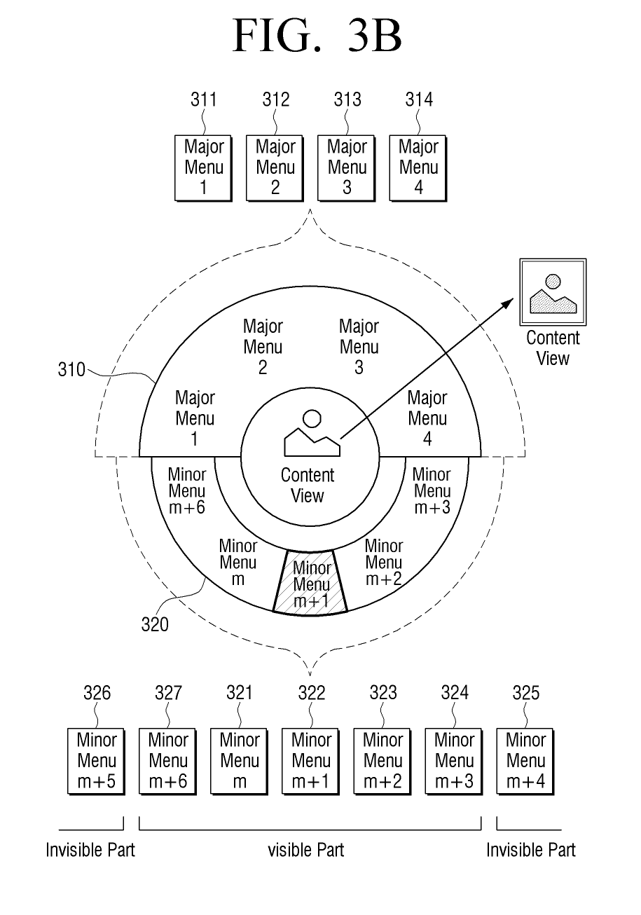

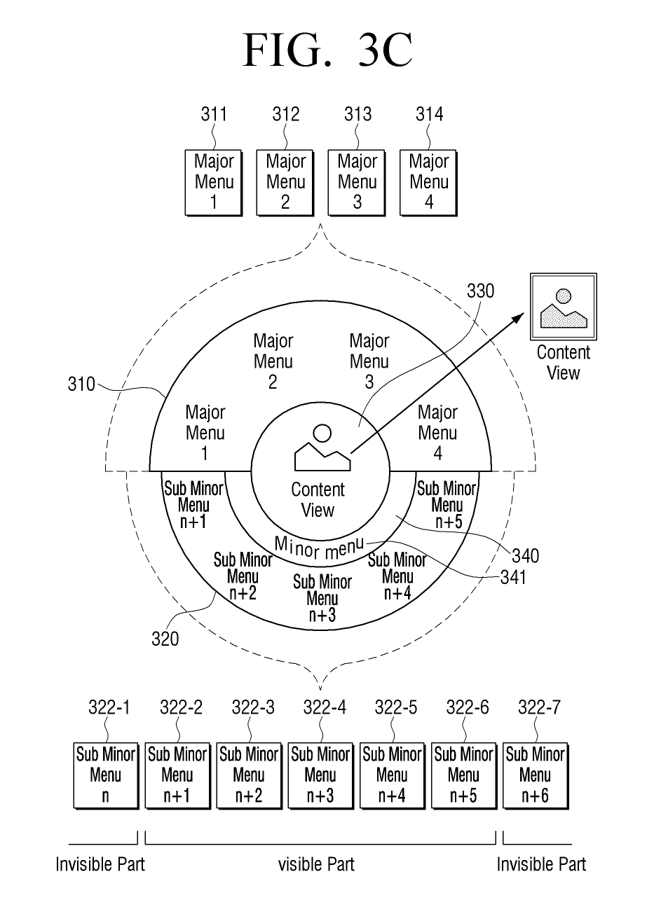

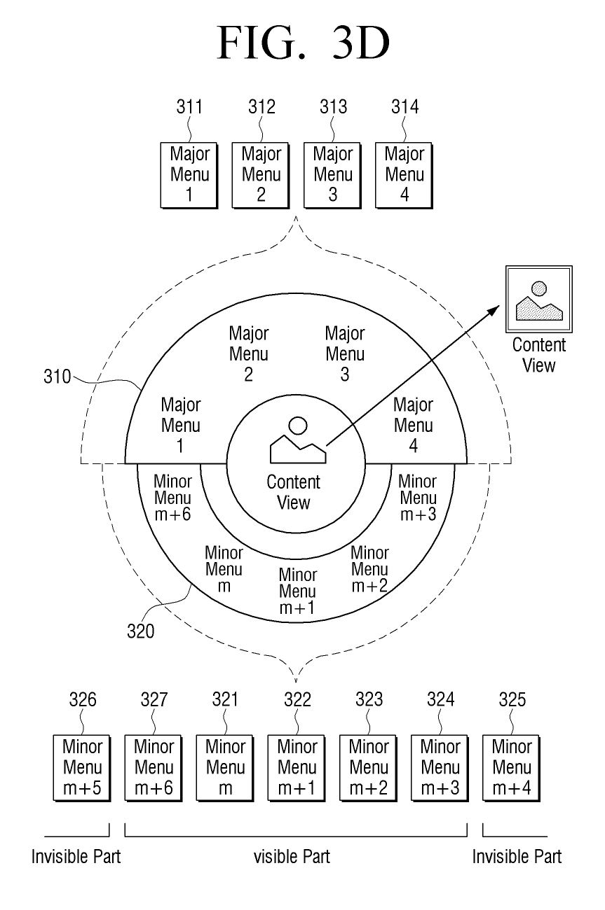

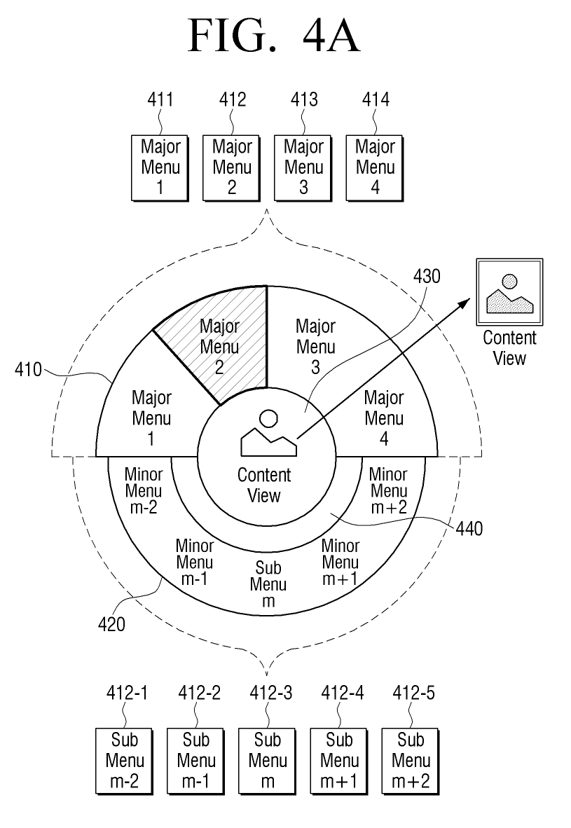

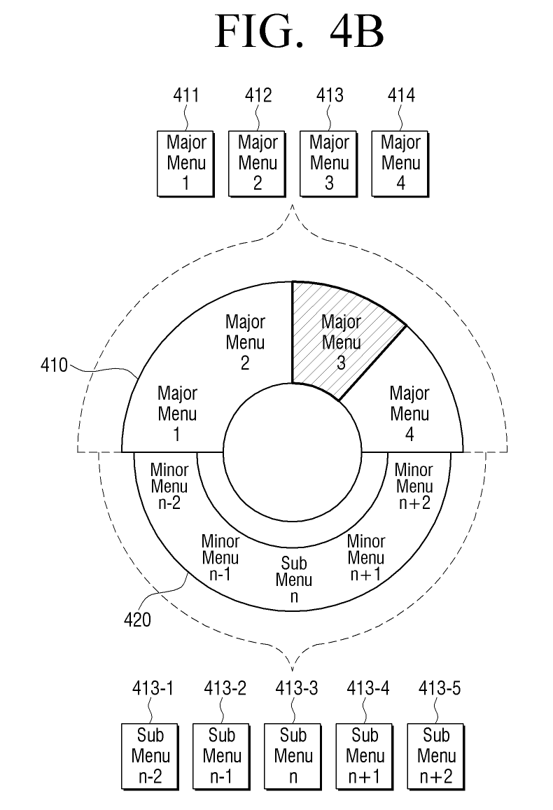

Hereinafter, an interaction performed through a UI will be described in detail with reference to FIGS. 3A to 4B.

Referring to FIG. 3A, a scroll 350 in the counterclockwise direction is input to a visible part of a second UI 320.

In this example, the processor 120 may move the menu items 321 to 327 included in the second UI 320 to the counterclockwise direction. Accordingly, referring to FIG. 3B, the menu item 322 may be moved to a region in which the menu item 324 is located.

In response to a user input for selecting one of the UI elements included in the second UI, the processor 120 may display at least one sub UI element for the selected UI element in the second UI.

The user input may be a touch input which taps one of the UI elements.

The sub UI element may be a UI element having a lower depth level than the selected UI element. For example, in response to the UI element having a hierarchical structure, a lower node of the selected UI element may be the sub UI element.

For example, as illustrated in FIG. 3B, the menu item 322 in the second UI 320 is selected.

In this example, referring to FIG. 3C, the processor 120 may display sub menu items 322-1-322-7 for the selected menu item 322 in the second UI 320. Even in this example, partial menu items 322-2-322-5 may be included in a visible part, and the remaining sub menu items 322-1 and 322-7 may be included in an invisible part. Positions of the sub menu items 322-1 to 322-7 may be changed through the scroll.

The processor 120 may display the selected UI element in a region between the first UI and the second UI.

In response to a user input for selecting a UI element displayed in the region between the first UI and the second UI being received, the processor 120 may display the selected UI element in the second UI.

For example, in response to one of the plurality of UI elements included in the second UI being selected, the processor 120 may display a sub UI element for the selected UI element in the second UI, and display the selected UI element in a region between the second UI and the circular UI.

In response to receiving a user input for selecting the UI element displayed in the region between the second UI and the circular UI, the processor 120 may display UI elements having the same depth (i.e., hierarchical) level as the selected UI element in the second UI. That is, the processor 120 may display the UI element displayed in the second UI before the sub UI element is displayed in the second UI again.

For example, referring to FIGS. 3C and 3D, in response to the menu item 322 being selected, the processor 120 may display a UI 340 including a menu item 341. In this example, the processor 120 may display the menu item 322 itself or may display information (for example, a name, an image, and the like) for the menu item 322.

In response to displaying the menu item 341, the processor 120 may display a menu item having the same depth (i.e., hierarchical level) as the menu item 341, that is, the menu items 321 to 327 in the second UI 320. The menu items 321 to 324, and 327 may be included in a visible part of the second UI 320, and the menu items 325 and 326 may be included in an invisible part of the second UI 320.

In response to selecting one of the plurality of UI elements included in the first UI, the processor 120 may display a sub UI element in the second UI.

Referring to FIG. 4A, in response to selecting a menu item 412, the processor 120 may display a plurality of sub menu items 412-1 to 412-5 for the selected menu item 412 in the second UI 420. Although not shown in FIG. 4A, other sub menu items having the same depth as the sub menu items 412-1 to 412-5 may be included in an invisible part of the second UI 420.

In this example, in response to selecting one among the sub menu items 412-1 to 412-5, the processor 120 may control a function related to the selected menu item to be performed.

For example, if the sub menu item 412-2 is selected, the processor 120 may display the selected sub menu item 412-2 in a UI 430, and display information (for example, a name, an image, and the like) for the selected sub menu item 412-2 in the UI 440.

Referring to FIG. 4B, in response to selecting the menu item 413, the processor 120 may remove the plurality of sub menu items 412-1 to 412-5, and display the plurality of sub menu items 413-1 to 413-5 for the selected menu item 413 in the second UI 420.

In this example, the sub menu items 412-2 displayed in the UIs 430 and 440 and information therefor may be removed.

Hereinafter, a specific example which provides a UI in a display apparatus will be described with reference to the accompanying drawings.

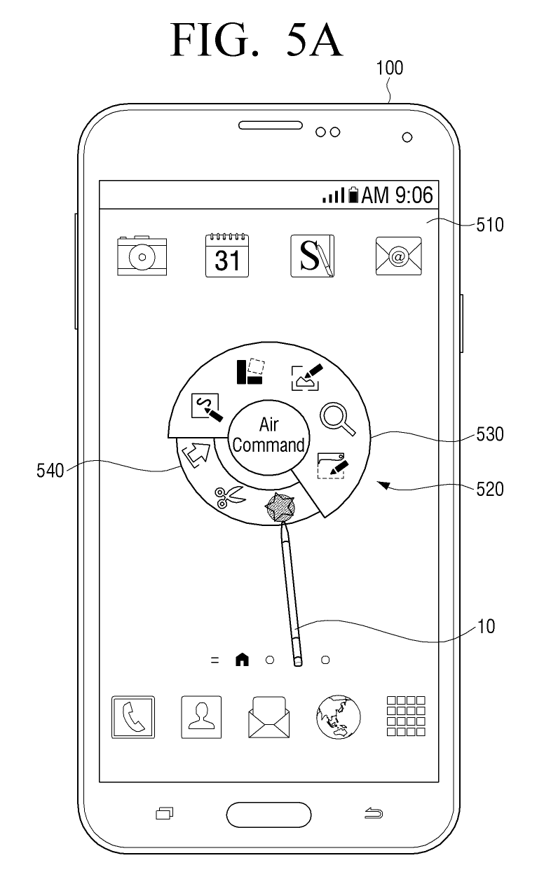

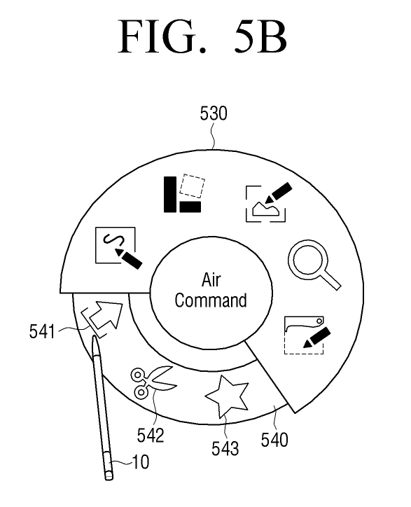

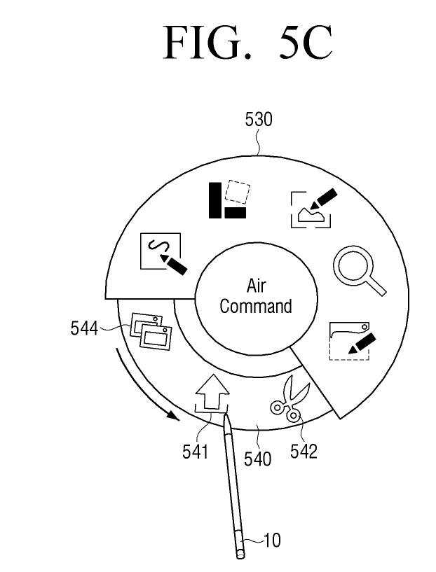

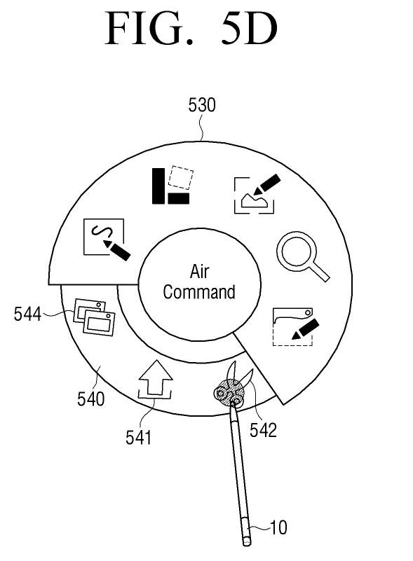

FIGS. 5A to 5D illustrate an example in which a display apparatus provides a UI according to an embodiment of the present disclosure.

Referring to FIGS. 5A to 5D, an example is illustrated in which the display apparatus 100 is implemented with a smart phone, and provides a UI 520 on a home screen 510.

For example, referring to FIG. 5A, in response to detecting a change in an intensity of an electromagnetic field by a pen 10, the processor 120 may control the display 110 to provide the UI 520.

In this example, the UI 520 may include a first UI (a static/fixed part) 530 in which five main menu items are displayed and a second UI (a scrollable part) 540 in which three sub menu items are displayed.

The main menu items may be displayed in fixed positions in the first UI 530, and the sub menu items may be displayed in the second UI 540 in a scrollable manner.

For example, referring to FIGS. 5B and 5C, in response to receiving a touch input by the pen 10 for scrolling the second UI 540 in the counterclockwise direction, the processor 120 may move sub menu items 541-543 included in the second UI 540 in the counterclockwise direction.

In this example, the sub menu item 543 displayed in the second UI 540 may be removed from a screen, and a sub menu item 544 may be newly displayed on the screen.

In response to receiving a user input for selecting a menu item included in the first UI 530 and the second UI 540, the processor 120 may control the display apparatus 100 to perform a function mapped to the selected menu item.

For example, referring to FIG. 5D, in response to selecting the sub menu item 544 for performing a crop function, the processor 120 may perform the crop function on a partial region in the home screen according to the touch input through the pen 10.

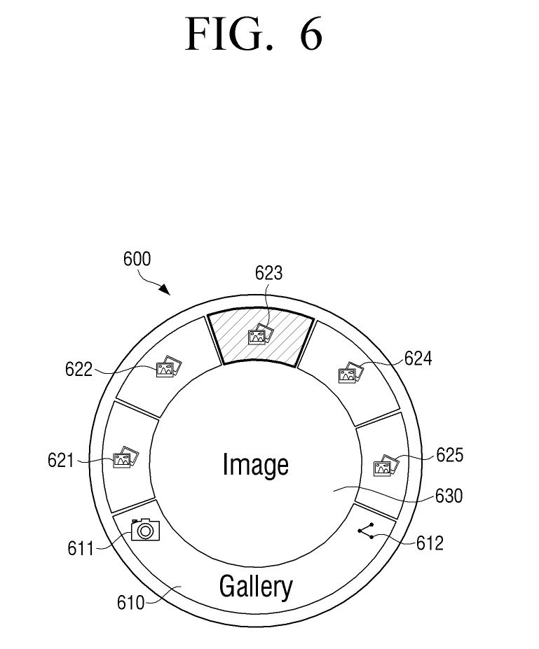

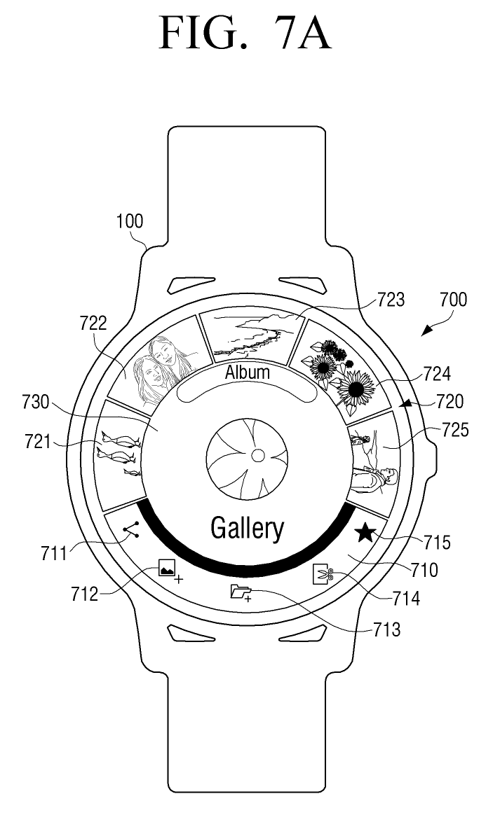

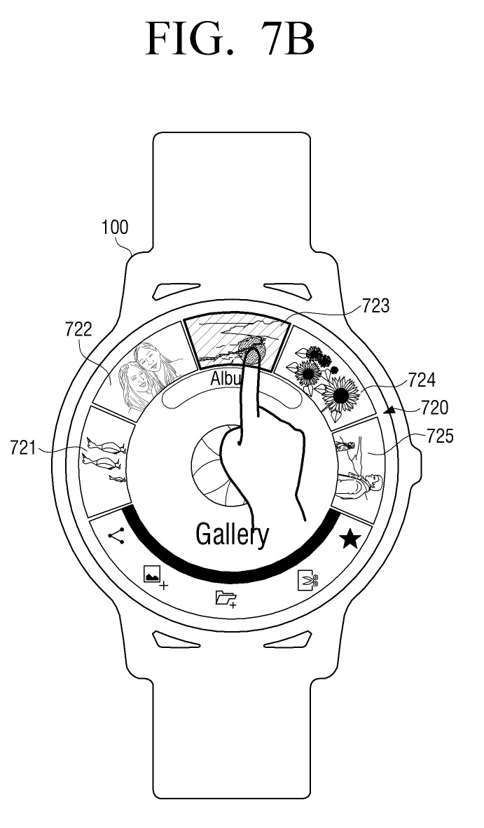

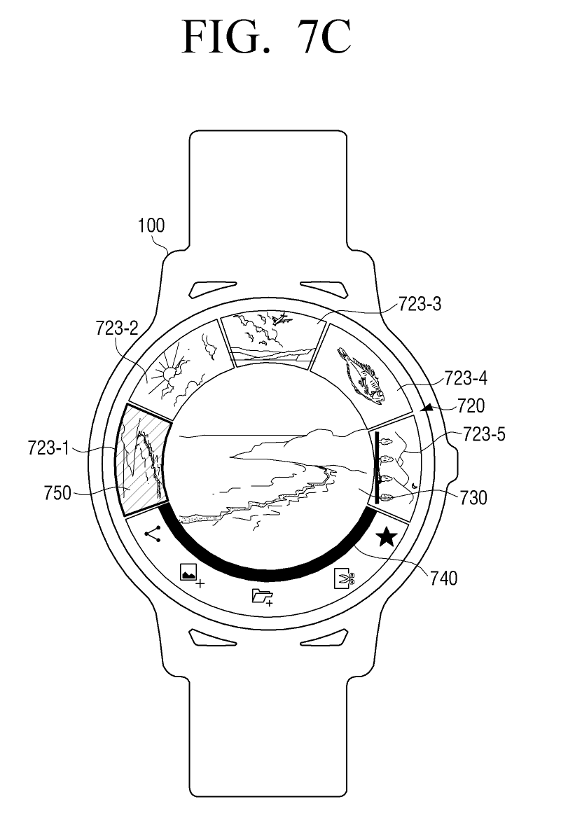

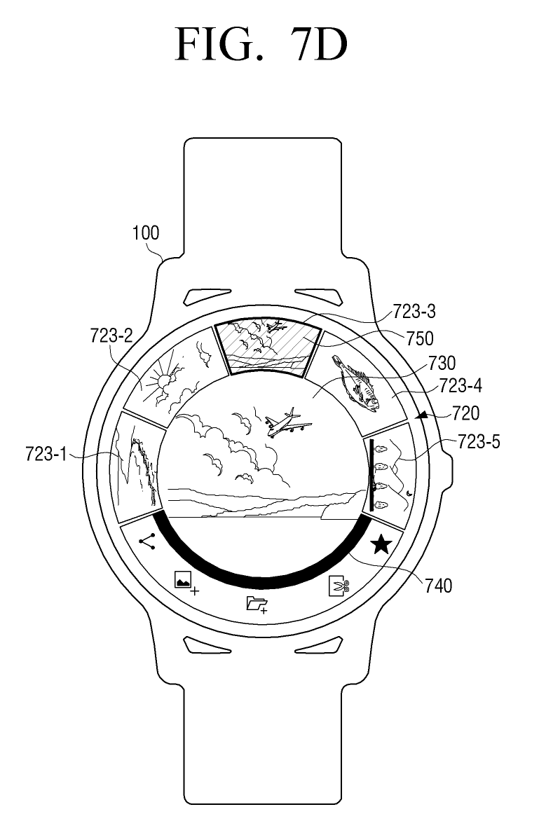

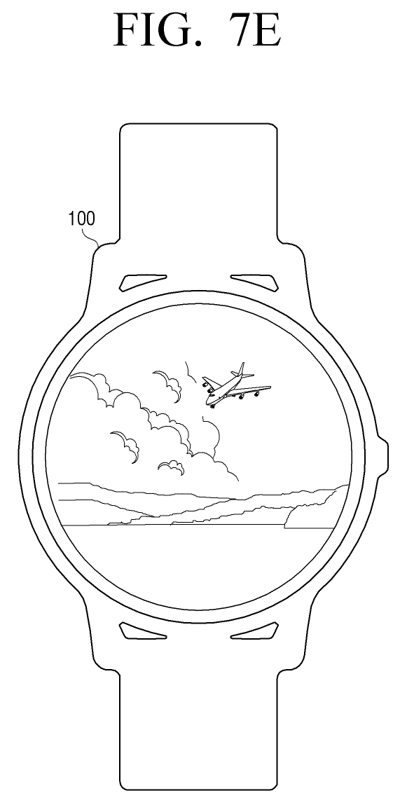

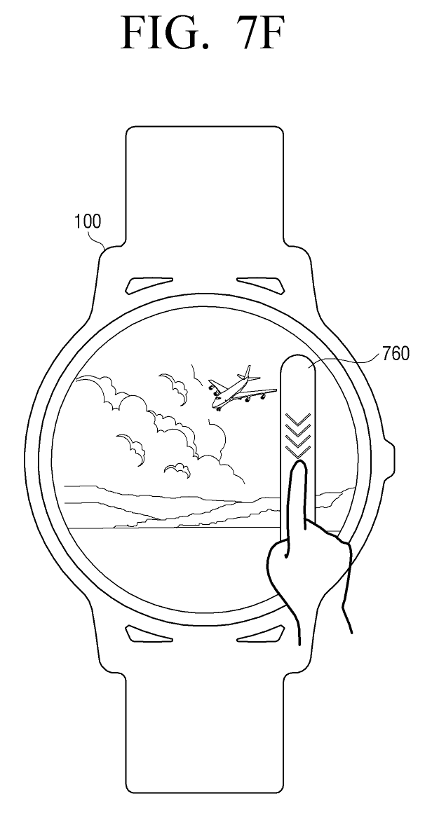

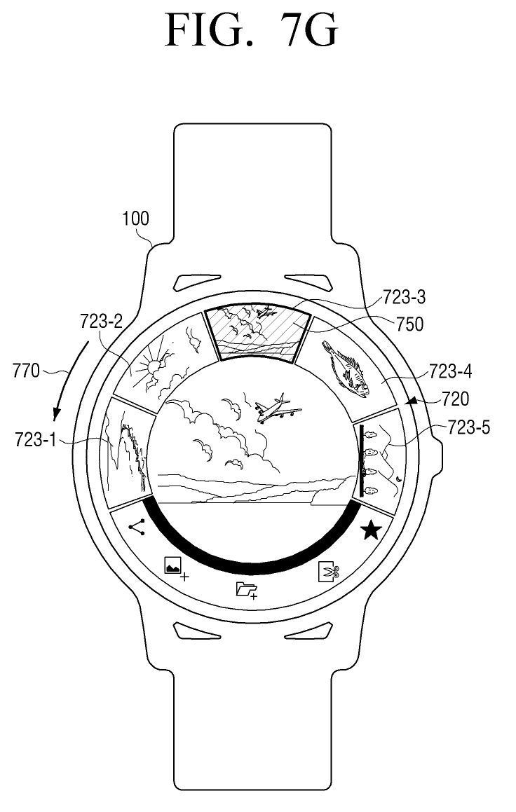

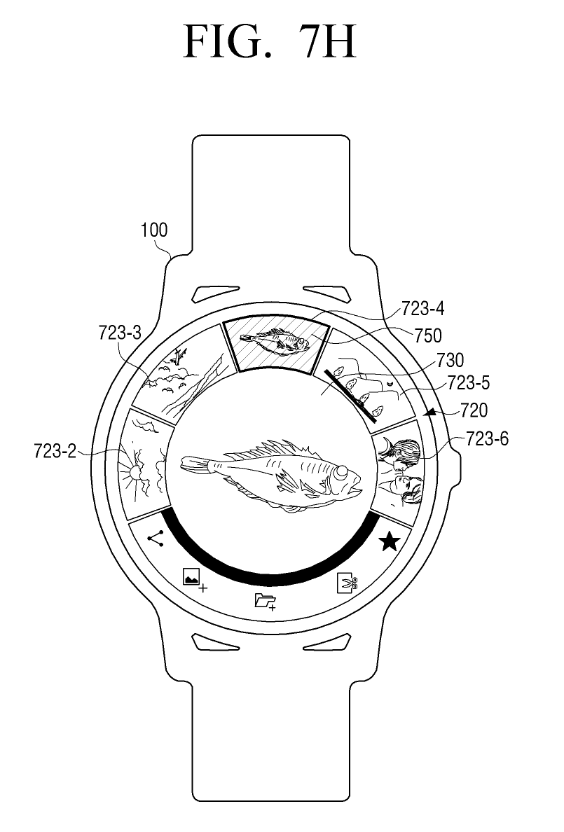

FIGS. 6, 7A, 7B, 7C, 7D, 7E, 7F, 7G, and 7H illustrate an example which provides a UI in a display apparatus according to an embodiment of the present disclosure.

Referring to FIGS. 6, 7A, 7B, 7C, 7D, 7E, 7F, 7G and 7H, an example is illustrated in which the display apparatus 100 is implemented with a smart watch, and provides a UI 620 on a gallery application execution screen 610 while a gallery application being performed.

FIG. 6 illustrates an example of a UI provided through a gallery application according to an embodiment of the present disclosure.

In response to selecting an icon for executing a gallery application among icons, the processor 120 may execute the gallery application, and control the display 110 to provide a UI 600 as illustrated in FIG. 6.

Referring to FIG. 6, the UI 600 may include a first UI 610 including menu items 611 and 612 for executing functions provided in the gallery application and a second UI 620 including images 621-625 provided in the gallery application.

The menu item 611 may indicate a menu item for performing a function for driving a camera of the display apparatus 100 to capture an image. The menu item 612 may indicate an item for performing a function to share the image with other users.

The images may be a thumbnail for an image, a thumbnail for an album including at least one image, a thumbnail for one of at least image included in the album, and the like.

The menu items 611 and 612 included in the first UI may be displayed in fixed positions, and the images 621 to 625 may be scrollably displayed.

A circular UI 630 which displays an image may be provided in a region between the first UI 610 and the second UI 620. For example, the image displayed in the UI 630 may be an image selected by the user among the images 621 to 625 included in the second UI.

Hereinafter, an interaction performed through a UI provided in a gallery application will be described in detail with reference to FIGS. 7A to 7H.

For example, in response to the gallery application being executed, the display apparatus 100 may display a UI 700 on a screen as illustrated in FIG. 7A.

For example, the UI 700 may include a first UI 710 including menu items 711-715 for executing functions provided in the gallery application, and a second UI 720 including album images 721-725 provided in the gallery application.

In this example, positions of the menu items 711 to 715 included in the first UI 710 may not be changed according to a user input, and the album images 721 to 725 included in the second UI 720 may be moved to the clockwise direction or the counterclockwise direction through a scroll input.

The menu item 711 may share an image with other users, the menu item 712 may add an image, the menu item 713 may add an album, the menu item 714 may crop an image, and the menu item 715 may bookmark an image.

The album images 721-725 may be thumbnails for one image among at least one image included in an album.

The processor 120 may control the display 110 to provide a circular UI 730 in a region between the first UI 710 and the second UI 720. A name, an image, and the like which indicate the gallery application may be displayed in the UI 730.

Referring to FIGS. 7B and 7C, in response to selecting image 723, the processor 120 may display images 723-1-723-5 in the second UI 720. In this example, the images 723-1-723-5 may be moved to the clockwise direction or the counterclockwise direction through the scroll input.

The processor 120 may display one of the images displayed in the second UI 720 in the UI 730. The image displayed in the UI 730 may be an image displayed in a region in which a graphic UI (GUI) (for example, highlight (see 750 of FIG. 7D)) is located in the second UI 720.

The processor 120 may display information (for example, name, capturing time, place, and the like) for the image 723-1 displayed in the UI 730 in a UI 740.

Referring to FIG. 7D, in response to selecting the image 723-3, the processor 120 may display the selected image 723-3 in the UI 730. The GUI 750 may be displayed in the selected image 723-3 to overlay with the image 723-3 selected by the user.

The processor 120 may display information (for example, name, capturing time, place, and the like) for the image 723-3 displayed in the UI 730 in the UI 740.

Referring to FIG. 7E, in response to selecting the image 723-3, the processor 120 may display the selected image 723-3 in a full-screen form.

Referring to FIGS. 7F and 7G, in response to a user input (that is, back gesture 760) for returning to a previous screen while the image 723-3 is displayed in the full-screen form, the processor 120 may display the previous UI before the image 723-3 was displayed in the full-screen form.

Then, in response to receiving a scroll 770 for moving the images 723-1-723-5 by one column to the counterclockwise direction, the processor 120 may display the images 723-0-723-5 by moving the images 723-1-723-5 in the counterclockwise direction.

That is, referring to FIG. 7H, the images 723-1-723-5 included in a visible part of the second UI 720 may be moved in the counterclockwise direction. For example, the image 723-1 included in the visible part may be removed, and an image 723-6 may be displayed.

In this example, the processor 120 may display the image 723-4 which overlays with the GUI 750 in the second UI 720 in the UI 730.

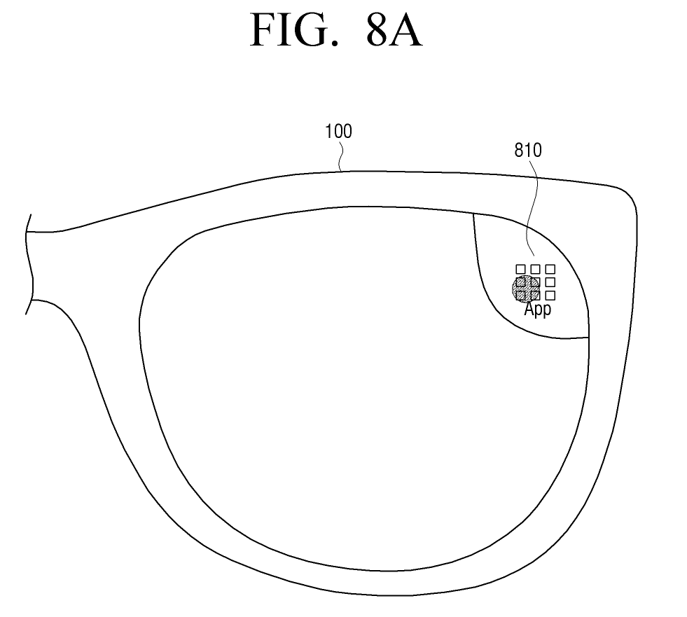

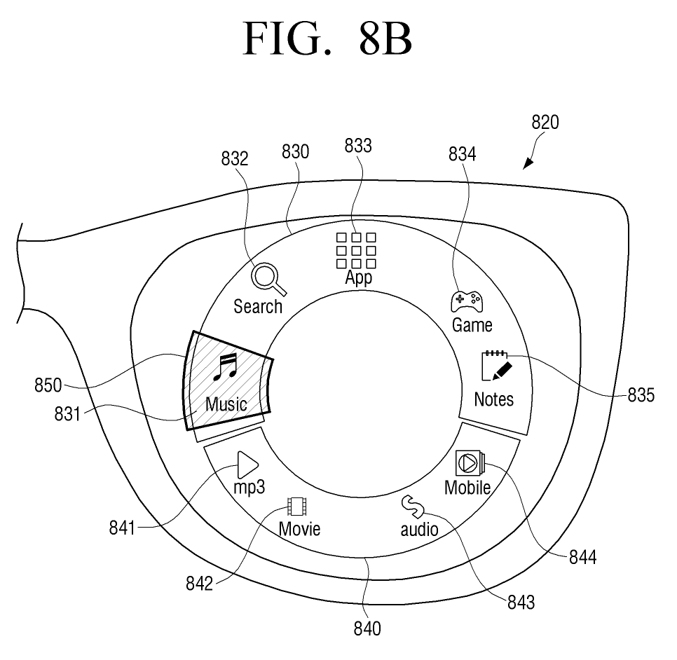

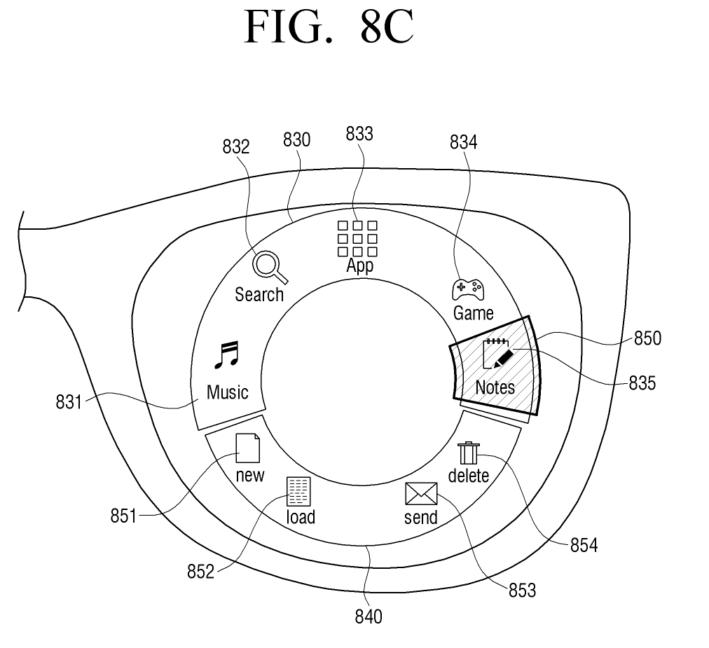

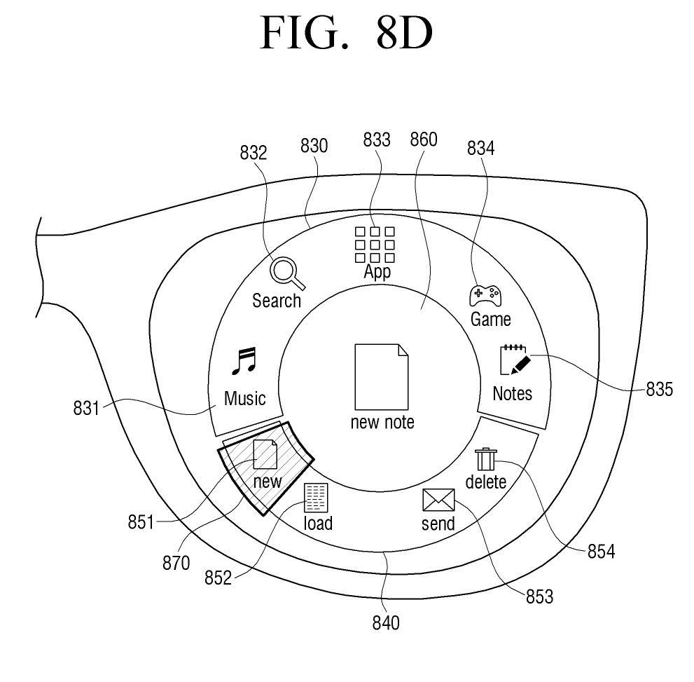

FIGS. 8A to 8D illustrate an example which provides a UI in a display apparatus according to an embodiment of the present disclosure.

FIGS. 8A to 8D illustrate an example in which the display apparatus 100 is implemented as an augmented reality interface to provide a UI 810.

For example, referring to FIGS. 8A and 8B, in response to a menu item 810 displayed in smart glasses being selected, the processor 120 may display a UI 820. In this example, a selection command for the menu item 810 may be performed through the user's voice.

The UI may include a first UI including a menu item for executing an application and a second UI including a menu item for executing a function provided in the application.

For example, as illustrated in FIG. 8B, in response to selecting a menu item 831 for executing a music application, the processor 120 may display menu items 841 to 844 for executing functions provided in the music application in a second UI 840.

In this example, the selection command for the music application may be performed through the user's voice, and the GUI 850 may be displayed to overlay with the selected menu item 831.

The menu items 831 to 835 included in the first UI may be displayed in fixed positions, and the menu items 841 to 844 included in the second UI may be scrollably displayed. The scroll input for the menu items 841 to 844 may be performed through the user's voice.

Referring to FIG. 8C, in response to selecting the menu item 835 for executing a memo application in the first UI 830, the processor 120 may display the menu items 851-854 for executing functions provided in the memo application in the second UI 840.

In this example, the selection command for the memo application may be performed through the user's voice, and the GUI 850 may be displayed to overlay with the selected menu item 835.

In response to one selecting a menu item in the second UI, the processor 120 may control the display apparatus 100 to perform the function for the selected menu item. The selection command for the menu item may be performed through the user's voice.

For example, referring to FIG. 8D, in response to selecting a menu item 851 for writing a new memo, the processor 120 may execute a memo application, and display a memo pad provided in the memo application in a circular UI 860.

In this example, a GUI 870 may be displayed in the selected menu item 851 to overlay with the selected menu item 851.

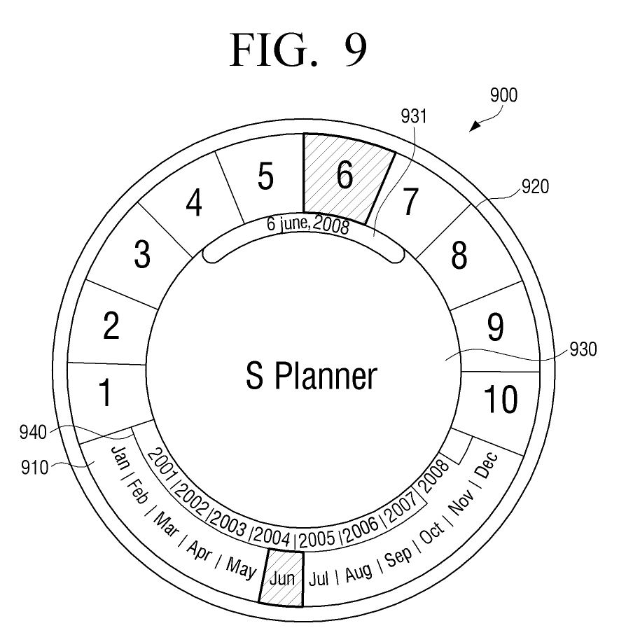

FIG. 9 illustrates an example of a UI provided through a calendar application according to an embodiment of the present disclosure.

In response to selecting an icon for executing a calendar application, the processor 120 may control the display 110 to provide a UI 900 as illustrated in FIG. 9 by executing the calendar application.

Referring to FIG. 9, the UI 900 may include a first UI 910 including menu items for setting a month in the calendar application and a second UI 920 including menu items for setting a day in the calendar application.

For example, the menu items included in the first UI may be displayed in fixed positions, and the menu items included in the second UI may be scrollably displayed.

A circular UI 930 which displays schedule information stored according to dates may be provided in a region between the first UI 910 and the second UI 920. For example, information 931 for a date selected to set a schedule by the user may be displayed in the UI 930.

A UI 940 including menu items for setting a year in the calendar application may also be displayed in a region between the first UI 910 and the UI 930.

For example, the menu items included in the UIs 920 and 940 may be scrolled.

In this example, in response to a scroll input for the menu item in the second UI 920, the processor 120 may display another date other than the displayed date in the second UI 920 by scrolling the menu item included in the second UI 920. In response to a scroll input for the menu item included in the UI 940, the processor 120 may display another year other than the displayed year in the UI 940 by scrolling the menu item included in the UI 940.

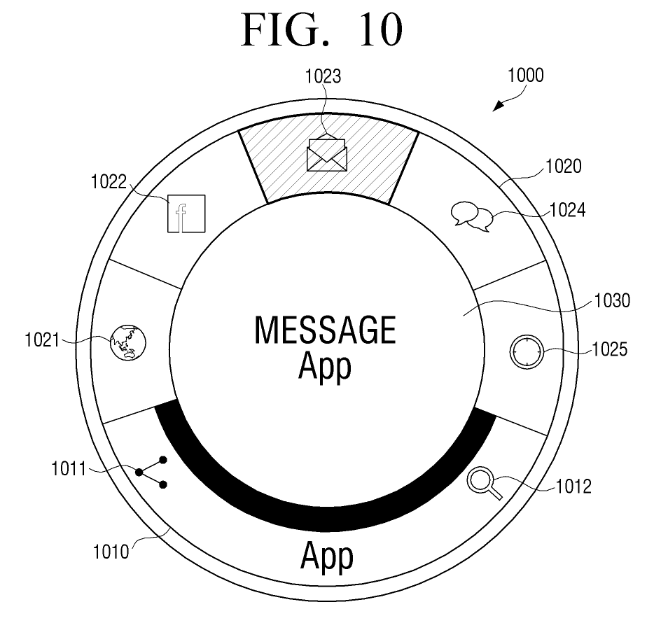

FIG. 10 illustrates an example that a display apparatus provides a UI according to an embodiment of the present disclosure.

Referring to FIG. 10, an example is illustrated in which the display apparatus 100 provides a UI on a home screen.

For example, referring to FIG. 10, the display apparatus 100 may control the display to provide a UI 1000 on the home screen.

In this example, a UI 1000 may include a first UI 1010 in which two main menu items 1011 and 1012 are displayed, and a second UI 1020 in which five sub menu items 1021-1025 are displayed.

The main menu item 1011 may be a menu item for performing a sharing function, and the main menu item 1012 may be a menu item for performing a search function for applications installed in the display apparatus 100.

The sub main menu items 1021-1025 may be menu items for executing applications installed in the display apparatus 100.

The main menu items 1011 and 1012 may be fixedly displayed in the first UI 1010, and the sub menu items 1021 to 1025 may be scrollably displayed in the second UI 1020.

In response to selecting the sub menu item 1023 in the second UI 1020, the processor 120 may display information (for example, name, image, and the like) for an application indicating the selected sub menu item in a UI 1030.

In response to the information for the application displayed in the UI 1030 being selected, the processor 120 may execute the selected application, and the processor 120 may display an execution screen of the executed application in the UI 1030 or display the execution screen in a full screen form.

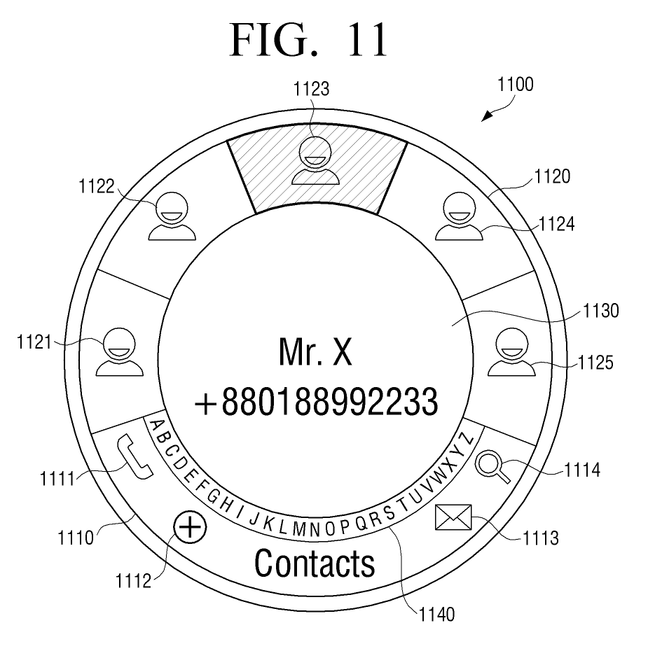

FIG. 11 illustrates an example of a UI provided through a contact application according to an embodiment of the present disclosure.

Referring to FIG. 11, in response to selecting an icon for executing the contact application, the processor 120 may control the display 110 to provide a UI 1100 by executing the contact application.

Referring to FIG. 11, the UI 1100 may include a first UI 1110 in which menu items 1111-1114 for executing functions provided in the contact application are displayed and a second UI 1120 in which images 1121-1125 for users stored in the contact application are displayed.

The menu item 1111 may be a calling function, the menu item 1112 may add other users to the contacts, the menu item 1113 may perform a messaging function, and the menu item 1114 may perform a contact search function.

The images 1121-1125 may be thumbnail images for the users stored in the contact application.

The main menu items 1111-1114 may be fixedly displayed in the first UI 1110 and the images 1121-1125 may be scrollably displayed in the second UI 1120.

In response to selecting the image 1123, the processor 120 may display contact information (for example, name, phone number, and the like) for the selected user in a UI 1130. In response to the contact information displayed in the UI 1130 being selected, the processor 120 may control the display apparatus 100 to call the selected user using a phone number included in the selected contact information.

The processor 120 may display a UI 1140 including indexes of the users in a region between the first UI 1110 and the UI 1130.

In this example, in response to selecting the index in the UI 1140, the processor 120 may display images for users having names beginning with the selected index in the second UI 1120.

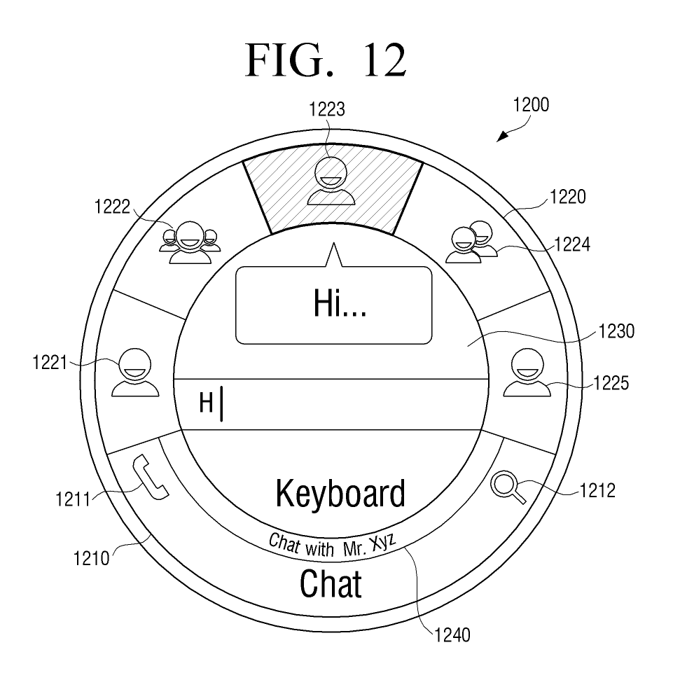

FIG. 12 illustrates an example of a UI provided through a message application according to an embodiment of the present disclosure.

Referring to FIG. 12, in response to selecting an icon for executing the message application, the processor 120 may control the display 110 to provide a UI 1200 by executing the message application

The UI 1200 may include a first UI 1210 in which menu items 1211 and 1212 for executing functions provided in the message application are displayed and a second UI 1220 in which images 1221-1225 for indicating chatting performed in the message application are displayed.

The menu item 1211 may perform a calling function, and the menu item 1212 may search for a chatting party.

The images 1221-1225 may be images for indicating parties of chatting performed in the message application. The chatting party may be one person or several persons.

The menu items 1211 and 1212 may be fixedly displayed in the first UI 1210 and the images 1221 to 1225 may be scrollably displayed in the second UI 1220.

In response to selecting the image 1223, the processor 120 may display a message input window, a virtual keyboard, and message contents for message transmission to the selected chatting party in the UI 1230.

The processor 120 may control the display apparatus 100 to perform chat through the UI 1230.

The processor 120 may display information (for example, a name of a party) for the chatting party in a UI 1240 between the first UI 1210 and the UI 1230.

The user UIs according to an embodiment of the present disclosure may be provided through various applications.

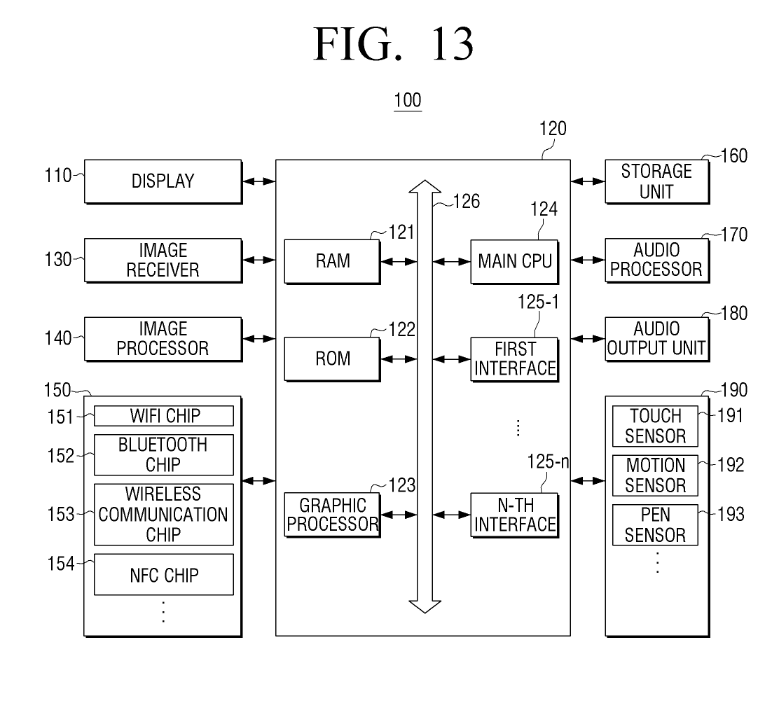

FIG. 13 is a block diagram of a display apparatus according to an embodiment of the present disclosure.

Referring to FIG. 13, the display apparatus 100 may include an image receiver 130, an image processor 140, a communication unit 150, a storage unit 160, an audio processor 170, an audio output unit 180, and a detector 190 in addition to the display 110 and the processor 120.

The display 110 and the processor 120 have been described above with reference to FIG. 1, and thus detailed description thereof will be omitted.

The image receiver 130 may receive image data through various sources. For example, the image receiver 120 may receive broadcast data from an external broadcasting station, receive video on demand (VOD) data from an external server in real time, and receive image data from an external apparatus.

The image processor 140 may be configured to perform processing on the image data received by the image receiver 130. The image processor 140 may variously perform image processing on the image data, such as decoding, scaling, noise filtering, frame rate conversion, and resolution conversion for the image data.

The display 110 may display image data that is processed in the image processor 140 or various screens generated in a graphics processor 123.

The communication unit 150 may be configured to perform communication with various types of external apparatuses according to various types of communication methods. The communication unit 150 may include a Wi-Fi chip 151, a Bluetooth chip 152, a wireless communication chip 153, a near field communication (NFC) chip 154, and the like. The processor 120 may perform communication with various types of external apparatuses using the communication unit 150.

For example, the Wi-Fi chip 151 and the Bluetooth chip 152 may perform communication in a Wi-Fi manner and a Bluetooth manner, respectively. In response to using the Wi-Fi chip 151 or the Bluetooth chip 152, the communication unit 150 may first transmit/receive a variety of connection information such as a service set identifier (SSID) and a session key, perform communication connection using the connection information, and transmit/receive information. The wireless communication chip 153 may configured to perform communication according to various communication standards, such as Institute of Electrical and Electronics Engineers (IEEE) standard, Zigbee®, 3rd generation (3G), 3G partnership project (3GPP), or long term evolution (LTE). The NFC chip 154 may be configured to operate in an NFC manner using a band of 13.56 MHz among various radio frequency identification (RF-ID) frequency bands such as 135 kHz, 13.56 MHz, 433 MHz, 860 to 960 MHz, and 2.45 GHz

The storage unit 160 may store a variety of program and data required for an operation of the display apparatus 100. The storage unit 160 may include a flash memory, a hard disk drive (HDD), or a solid state drive (SSD). The storage unit 160 may be accessed by the processor 120, and perform readout, recording, correction, deletion, update, and the like on data by the processor 120.

For example, the storage unit 160 may store program, data, and the like for forming various screens to be displayed in a display region.

The audio processor 170 may be configured to perform processing on audio data. The audio processor 170 may variously perform processing on the audio data, such as decoding, amplification, and noise filtering for the audio data. The audio data processed in the audio processor 170 may be output to the audio output unit 180.

The audio output unit 180 may be configured to output a variety of audio data from the audio processor 170 or to output various alarm sounds or voice messages. For example, the audio output unit 180 may be implemented with a speaker. However, the audio output unit 180 may be implemented with output terminals which may output the audio data.

The detector 190 may be configured to detect various user interactions. The detector 190 may detect at least one among various variations of the display apparatus 100 such as posture change, illumination change, or acceleration change, and transmit electrical signals corresponding to the detected variations to the processor 120. For example, the detector 190 may detect a state change based on the display apparatus 100, generate a detection signal according to the state change, and transmit the generated detection signal to the processor 120.

For example, a touch sensor 191 may be configured to detect a touch input of the user using a touch sensor attached to a rear of a display panel. The processor 120 may determine the kind of touch input (for example, tap, scroll, and the like) by acquiring information such as touch coordinates, a touch time, and the like from the touch sensor 191. The touch sensor 191 may directly determine the kind of touch input using the acquired touch coordinates, touch time, and the like.

A motion sensor 192 may be configured to detect a motion (for example, rotation motion, tilting motion, and the like) of the display apparatus 100 using at least one among an acceleration sensor, a tilt sensor, a gyro sensor, and a 3-axis magnetic sensor. The motion sensor 192 may transmit a generated electrical signal to the processor 120.

A pen detector 193 may detect a touch input or a proximity input according to intensity change of an electromagnetic field by proximity or touch of a pen (for example, a digitizer pen) in which a resonant circuit is built, and transmit a generated electrical signal to the processor 120.

The processor 120 may be configured to control an overall operation of the display apparatus 100 using a program stored in the storage unit 160.

The processor 120 may include a RAM 121, a ROM 122, the graphics processor 123, a main CPU 124, first to n-th interfaces 125-1 to 125-n, and a bus 126. The RAM 121, the ROM 122, the graphics processor 123, the main CPU 124, the first to n-th interfaces 125-1 to 125-n, and the like may be electrically coupled through the bus 126.

A command set and the like for system booting is stored in the ROM 122. In response to a turn-on command being input, the main CPU 123 may copy an operating system (O/S) stored in the storage unit 160 to the RAM 121 according to a command stored in the ROM 122, and execute the O/S to boot a system. In response to the booting being completed, the main CPU 124 may copy various application programs stored in the storage unit 160 to the RAM 121, and execute the application programs to perform various operations.

The graphics processor 123 may be configured to generate a screen including various objects such as an icon, an image, text, and the like using an operation unit (not shown) and a rendering unit (not shown). The operation unit may calculate attribute values such as coordinate values, in which the objects are displayed according to a layout of a screen, shapes, sizes, and colors based on a control command received from the detector 190. The rendering unit may generate a screen having various layouts including the objects based on the attribute values calculated in the operation unit. The screen generated in the rendering unit is displayed in a display area of the display 110.

The main CPU 124 accesses the storage unit 140 to perform booting using the O/S stored in the storage unit 160. The main CPU 124 performs various operations using a variety of program, content, data, and the like that are stored in the storage unit 160.

The first to n-th interfaces 125-1 to 125-n are coupled to the above-described components. One of the interfaces may be a network interface coupled to an external apparatus through a network.

The processor 120 may control the display 110 to provide a first UI in which a plurality of UI elements are fixedly arranged to the radial direction and a second UI in which a plurality of UI elements are scrollably arranged to the radial direction.

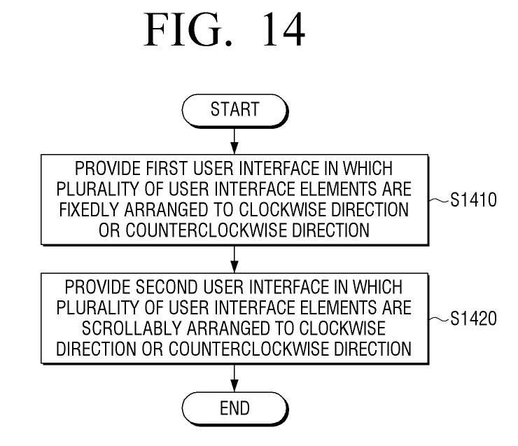

FIG. 14 is a flowchart of a method of providing a UI according to an embodiment of the present disclosure.

Referring to FIG. 14, the display apparatus may provide a first UI in which a plurality of UI elements are fixedly arranged to a clockwise direction or a counterclockwise direction at operation S1410.

The display apparatus may provide a second UI in which a plurality of UI elements are scrollably arranged to the clockwise direction or the counterclockwise direction at operation S1420.

The first UI and the second UI may be coupled in a circular form.

The plurality of UI elements included in the first UI may have a relatively higher priority than the plurality of UI elements included in the second UI.

In the UI providing method, in response to a user input for selecting one of the plurality of UI elements included in the second UI being received, the display apparatus may display at least one sub UI element for the selected UI element in the second UI.

The selected UI element may be displayed in a region between the first UI and the second UI.

In response to a user input for selecting the selected UI element displayed in the region between the first UI and the second UI being received, the display apparatus may display the selected UI element in the second UI.

In the UI providing method, in response to a user input for selecting one of the plurality of UI elements included in the first UI being received, the display apparatus may display a sub UI for the selected UI element in the second UI.

The contents related to the UI according to various embodiments of the present disclosure have been described in FIGS. 1 to 13.

The UI providing methods according to various embodiments of the present disclosure may be implemented in program and provided to the display apparatus 100. For example, a non-transitory readable medium in which the program including the UI providing method of the display apparatus 100 is stored may be provided.

The non-transitory readable medium is not a medium configured to temporarily store data such as a register, a cache, or a memory but an apparatus-readable medium configured to permanently or semi-permanently store data. For example, the programs may be stored in the non-transitory apparatus-readable medium such as a compact disc (CD), a digital versatile disc (DVD), a hard disk, a Blu-ray disc, a universal serial bus (USB), a memory card, or a ROM, and provided. The above-described programs may be stored in the storage unit 160 as an example of the non-transitory readable medium and provided.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A display apparatus comprising:
a display; and
a processor configured to control the display to provide a first graphical region having user interface elements along a radial direction in fixed positions and a second graphical region having user interface elements along the radial direction in scrollable positions.

2. The display apparatus of claim 1, wherein the first graphical region and the second graphical region are coupled to each other to form an annulus.

3. The display apparatus of claim 1, wherein the user interface elements in the first graphical region have a higher priority than the user interface elements in the second graphical region.

4. The display apparatus of claim 1, wherein, in response to a user input for selecting one a first user interface element from the second graphical region, the processor is further configured to display a sub user interface element for the first user interface element in the second graphical region.

5. The display apparatus of claim 4, wherein the processor displays the first user interface element in a third graphical region disposed between the first graphical region and the second graphical region.

6. The display apparatus of claim 5, wherein, in response to a user input for selecting the first user interface element displayed in the third graphical region, the processor is further configured to display the selected user interface element in the second user interface.

7. The display apparatus of claim 1, wherein, in response to a user input for selecting a second user interface element from the first graphical region, the processor displays a sub user interface for the second user interface element in the second graphical region.

8. The display apparatus of claim 1, wherein the first graphical region is a first semi-annulus and the second graphical region is a second semi-annulus.

9. The display apparatus of claim 8, wherein the first semi-annulus has a first inner radius and the second semi-annulus has a second inner radius.

10. The display apparatus of claim 9, wherein the processor is further configured to display a third graphical region as a third semi-annulus adjacent to the second inner radius of the second graphical region.

11. A method of providing a user interface of a display apparatus, the method comprising:
providing a first graphical region having user interface elements along a radial direction in fixed positions; and
providing a second graphical region having user interface elements along the radial direction in scrollable positions.

12. The method of claim 11, wherein the first graphical region and the second graphical region are coupled to each other to form an annulus.

13. The method of claim 11, wherein the user interface elements in the first graphical region have a relatively priority than the user interface elements in the second graphical region.

14. The method of claim 11, further comprising, in response to a user input for selecting a first user interface element in the second graphical region, displaying a sub user interface element for the first user interface element in the second graphical region.

15. The method of claim 14, further comprising displaying the first user interface element in a third graphical region disposed between the first third graphical and the second third graphical.

16. The method of claim 15, further comprising, in response to a user input for selecting the first user interface element displayed in the third graphical region, displaying the selected user interface element in the second user interface.

17. The method of claim 11, further comprising, in response to a user input for a second user interface element from the first graphical region, displaying a sub user interface for the second user interface element in the second graphical region.

18. The method of claim 11, wherein the first graphical region is a first semi-annulus and the second graphical region is a second semi-annulus.

19. The method of claim 11, wherein the first semi-annulus has a first inner radius and the second semi-annulus has a second inner radius.

20. The method of claim 19, further comprising displaying a third graphical region as a third semi-annulus adjacent to the second graphical region.
